(19) United States
(12) Patent Application Publication
(10) Pub. No.: US 2004/0162897 A1
(43) Pub. Date: Aug. 19, 2004

(54) System for displaying network equipment graphically and hierarchically, for use in a communication network management system

(75) Inventors: Michel Chevanne, Clamart (FR); Bertrand Lapraye, Gip Sur Yvette (FR)

Correspondence Address: SUGHRUE MION, PLLC, Suite 800, 2100 Pennsylvania Avenue N.W., Washington, DC, 20037-3213, US

(73) Assignee: ALCATEL

(21) Appl. No.: 10/673,458

(22) Filed: Sep. 30, 2003

(30) Foreign Application Priority Data
Oct. 10, 2002 (FR) 02 12 573

(51) Int. Cl. G06F 15/173

(52) U.S. Cl. 709/224

(57) ABSTRACT

A system (D) is dedicated to managing the display of images representing network equipments (NE) of a communication network. The equipments (NE) include elements associated with hierarchical levels, and each element is associated with a set of primary data which represents it within the level to which it belongs with no specific attachment to a level higher than its own and/or at least one set of secondary data which represents it within the level to which it belongs when it is attached to a level higher than or equal to its own. The system (D) includes management means (GM) adapted, in the event of receiving a request designating a chosen level of an equipment with or without attachment, to access the memory in which the sets of primary and secondary data are stored in order to extract therefrom the sets of primary or secondary data of the elements of the equipment that belong to the designated level and to levels lower than it, according to whether said level is designated with or without attachment.

The field of the invention is that of managing communication network equipment, and more particularly that of managing the display of images representing network equipment.

Network management systems (NMS), or network operating systems, as they are also known, have been designed to enable network managers, or operators, as they are also known, to manage and monitor the equipment that constitutes their networks. To this end these systems include dedicated tools, including a management tool for displaying on a screen, via a graphical interface, for example a graphical user interface (GUI), images realistically representing some of the network equipment, and in particular the configurations thereof. In the present context, “equipment” means any type of hardware, for example servers, terminals, switches, routers, or concentrators, capable of exchanging data with the network management system NMS in accordance with a network management protocol, such as the Simple Network Management Protocol (SNMP) of RFC 2571-2580.

These tools can be used to display elements and subelements constituting some of the equipment, for example racks, shelves, slots, integrated circuit cards, and even input/output ports. Sometimes the images are even accompanied with information representative of the states (or status) of the elements or subelements.

In the present context, the term “subelement” means an element belonging to a lower hierarchical level than that of an element into which it is integrated. Similarly, the term “sublevel” means the level of a subelement relative to the level of the element in which it is integrated.

Display tools of the above kind are described in U.S. Pat. No. 5,958,012, in the name of Computer Associates, or in European patent application EP 1 094 635, in the name of Nortel, or finally in the document “DualQuest: Real-Time bifocal network visualization system”, by Hiroko Fuji et al., IEICE Transactions on communication, Institute of Electronics Information and Communication Engineering, Tokyo, 1995, for example.

The above prior art tools are not entirely satisfactory in that they are dedicated exclusively to one type of equipment, with the result that they must be systematically modified each time that a new type of equipment is integrated into the network, or dedicated to many types of equipment, thanks to libraries of images, but without taking into account the hierarchical relationship of the elements and subelements that constitute the equipment, with the result that they cannot be used to “navigate” from one level to another, for example from racks to shelves.

An objective of the invention is therefore to remedy some or all of the drawbacks previously cited.

To this end it proposes a system dedicated to managing the display of images representing equipment of a communication network, said system including elements associated with hierarchical levels. The management system is characterized in that, firstly, each equipment element is associated with a set of primary data stored in a memory and which represents it (graphically) within the level to which it belongs with no specific attachment to a level higher than itself and/or at least one set of secondary data, also stored in the memory and which represents it (graphically) within the level to which it belongs when it is attached to a level higher than or equal to its own, and, secondly, in that it includes management means adapted, in the event of receiving a request designating a chosen level of an equipment with or without attachment, to access the sets of primary and secondary data in order to extract from the memory the sets of primary or secondary data of the elements of the equipment that belong to the designated level and to levels lower than it, according to whether said level is designated with or without attachment.

Because an element can have one or several graphical representations, depending on the levels to which they are attached, it is therefore possible to observe it in different forms as a function of the required level. In other words, it is now possible to zoom in on or out of subelements that constitute an element or elements that consist of subelements.

The management means can be adapted to send the sets of primary or secondary data extracted from the memory to a graphical interface, preferably a graphical user interface (GUI), of the network management system (NMS).

Furthermore, some elements can be associated with sets of primary and secondary data that are at least in part identical.

Moreover, the management means can be adapted to refresh the data of the elements displayed on receiving, for example from the network management system, a message reporting that an event relating to the elements displayed has occurred within the network.

The invention also relates to a communication network management server equipped with a management system of the type described hereinabove, where applicable integrated into its control module.

The invention can be used in all network technologies that must be managed, and in particular in transmission networks (for example WDM, SONET and SDH networks), data networks (for example Internet-IP and ATM networks), or voice networks (for example conventional, mobile and NGN networks).

Other features and advantages of the invention will become apparent on reading the following detailed description and examining the appended drawings, in which:

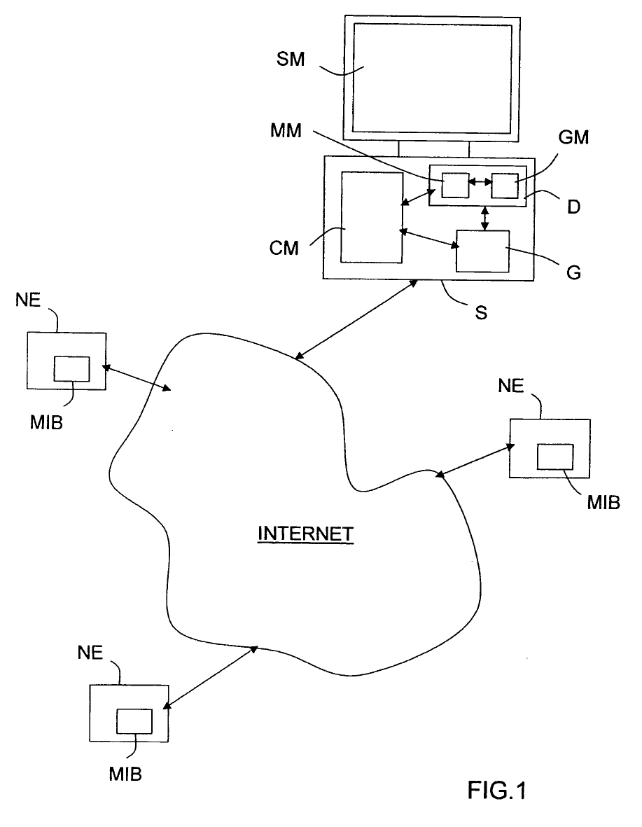

FIG. 1 shows diagrammatically a portion of one example of a communication network equipped with a system according to the invention,

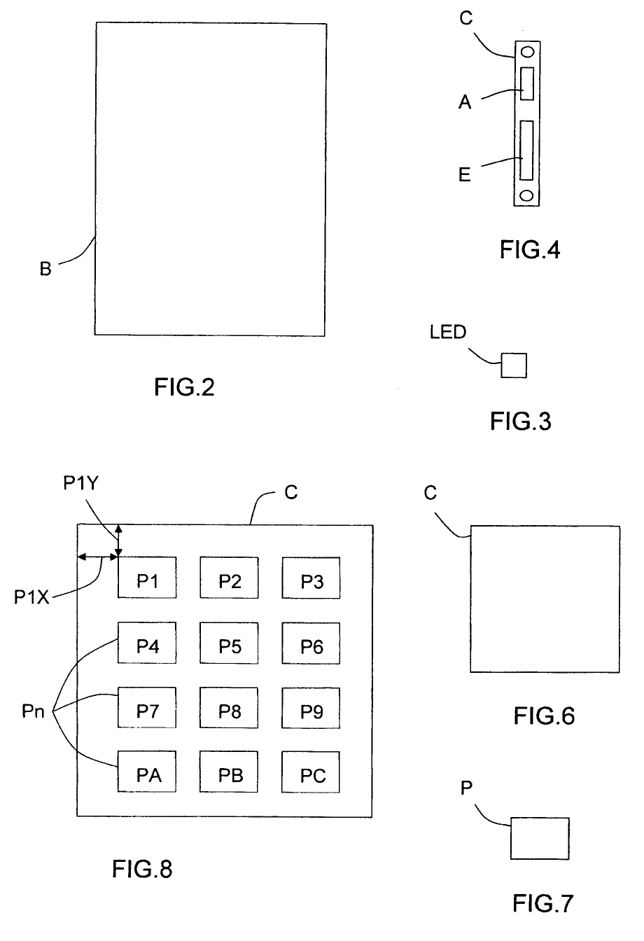

FIG. 2 is an image of a first model of an element, here a rack, belonging to the first hierarchical level of an equipment,

FIG. 3 is an image of a first model of an element, here a light-emitting diode (LED), belonging to the second hierarchical level of the equipment whose first level element is shown in FIG. 2,

FIG. 4 is an image of a first model of an element, here an integrated circuit card, belonging to the third hierarchical level of the equipment whose first level element is shown in FIG. 2,

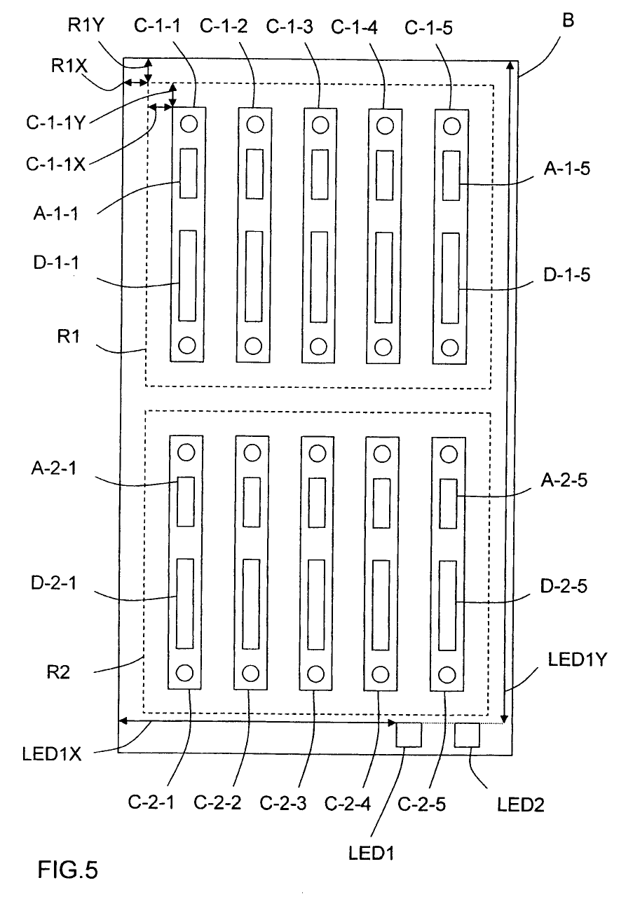

FIG. 5 is an image that is the result of superimposing the images of the first models of an element shown in FIGS. 2 to 4,

FIG. 6 is an image of a second model of the third level element of which a first model is shown in FIG. 4,

FIG. 7 is an image of a second model of an element, here an input/output port, belonging to the fourth hierarchical level of the equipment whose first level element is shown in FIG. 2, and

FIG. 8 is an image that is the result of superposing the images of second models of an element shown in FIGS. 6 and 7.

The drawings can not only constitute part of the description of the invention but also, if necessary, contribute to the definition of the invention.

The invention proposes a management system enabling the manager of a communication network, via the network management system, to display on a screen images representative of at least some of the network equipment.

In the remainder of the description, and by way of nonlimiting example, the communication network is considered to be of the Internet Protocol (IP) type. Of course, the invention applies to other types of network, for example to WDM, SONET and SDH transmission networks, ATM data networks, and conventional, mobile and NGN voice networks.

In the FIG. 1 example, the management system D according to the invention is installed in a management server S of the network management system (NMS) in order to cooperate with its control module CM. However, it could be installed in the control module CM and constitute one function thereof. Moreover, an NMS including a plurality of management servers each equipped with a management system D can be envisaged, each server being adapted to manage the display of images representing equipment included in portions of the network.

The management server S is preferably equipped with a graphical interface G, of the graphical user interface (GUI) type, for displaying images and information on the screen of its monitor SM.

The communication network includes a multiplicity of network equipments NE, for example servers, terminals, switches and routers, able to exchange data with the NMS, and in particular with its management server S, in accordance with a network management protocol (for example the Simple Network Management Protocol (SNMP) of RFC 2571-2580 or the CMISE/CMIP, CORBA or TL1 protocol).

Each network equipment NE conventionally includes a management information base MIB, or an object instance base as they are also known, comprising information fields whose specific values characterize it and are accessible to the NMS.

Finally, the control module CM of the management server S stores management information base definitions representative, for each network equipment NE managed, of its attributes, and in particular of the text that describes it, its rights of access, and the hierarchical organization of the levels to which the elements that constitute it belong.

The elements that constitute a network equipment NE are organized into hierarchical levels, of which the first is by definition the highest.

For example, a network equipment NE can include one or more racks Bi each of which can accommodate one or more light-emitting diodes LEDk and/or one or more shelves Rj each of which can receive one or more integrated circuit cards C-j-m each of which can include one or more input/output ports P-j-m-n.

Moreover, according to the invention, a network equipment NE has at least one graphical representation defined by a data file stored in a memory M in a chosen format, for example the Graphical Interchange Format (GIF) or the Joint Photographic Expert Group (JPEG) format. For example, in the case of the breakdown previously cited, the file names can be Bi.gif, LEDk.gif, Rj.gif, C-j-m.gif and P-j-m-n.gif.

These representations enable the manager of the network to display on the screen of the monitor SM of his management server S, using the management system D according to the invention, images of the network equipments NE managed by said server, where applicable accompanied by information specifying, in particular, the status of their respective elements (including certain alarm states), supplied by the control module CM of said server S.

To be more precise, the invention defines two types of graphical representation respectively corresponding to primary and secondary element models. By definition, a primary element model is a first graphical representation of the element within the level to which it belongs and with no specific attachment to a level higher than its own, defined by primary data in the form of a primary file. Moreover, a secondary element model is a second graphical representation of the element within the level to which it belongs, but with a specific attachment to a level higher than or equal to its own, defined by secondary data in the form of a secondary file.

Accordingly, an element of a level X can have one or more representations optionally associated with different levels of representation.

For example, an element may have only a primary model that represents it within its own level, with no attachment to any level higher than its own. This applies to the rack B, for example, belonging to the first level, shown in FIG. 2 in the form of a rectangle, and the light-emitting diodes LED, belonging to the second level, shown in FIG. 3 in the form of a square. In this case, the graphical representation of the element can be displayed on a screen only provided that its display or the display of an element of a higher level than its own has been requested, with no attachment to any particular level.

In another example, an element of a chosen level may have a primary model that represent it within its own level, but without attachment to any particular level, and a secondary model that represents it within its own level, but with attachment to that level or to a higher level. This is the case, for example, of the card Cm shown in a first manner in FIG. 4 (detailed and realistic primary model representing two input/output connectors A and E) and in a second manner in FIG. 6 (secondary model (simple rectangle)). Here the card Cm, which belongs to the third level (X=3), has a primary model (FIG. 4) that represents it within said third level, but without attachment to any level, and a secondary model (FIG. 6) that represents it within said third level, but with attachment to that third level.

In this case, if the display of an element of a chosen level higher than that of the card (for example the first or second level) and elements of lower level than the chosen level but with no attachment between said chosen level and the elements belonging to said lower levels is requested, only the first representations of the elements of the various levels are displayed, where they exist. On the other hand, if the display of an element of a chosen level and of elements of lower levels than the chosen level is requested, with attachments between said chosen level and the elements belonging to said lower levels, then only the second representations of the designated element of the chosen level and of the elements of lower levels than the chosen level are displayed, when the latter exist. In the example previously cited relating to a card, the primary model of the card is displayed if the display is requested of an element of the first or the second level without attachment to the lower levels and the secondary model of the card is displayed only if the display of said card is requested with an attachment to the elements of the lower levels (here the fourth level).

In another example, an element of a chosen level can have only a secondary model that represents it within said level, but attached to its own level or to a higher level. This is the case, for example, of the input/output ports P-j-m-n shown in only one manner in FIG. 7 (secondary model (simple rectangle)). Here, the input/output ports P-j-m-n, which belong to the fourth level (X=4), have only a secondary model that represents them within the fourth level, but attached to the third level (that of the cards C-j-m).

In this case, the graphical representation of an element (here an input/output port P-j-m-n) can be displayed on a screen only if the display of an element of a level higher than its own (here the third level to which the cards C-j-m belong) with its attachments to the elements of the lower levels has been requested. In other words, in this kind of situation, an element cannot be displayed if the display requested designates an element of a level higher than its own (and of elements of lower levels), with no attachment between said chosen level and said elements of lower levels.

Of course, an element can have a plurality of secondary models attached to (or associated with) elements belonging to different levels, and consequently allow the display of a plurality of different representations of the element, according to the level of display required.

It is important to note that a primary or secondary file, the data in which defines a primary or secondary model (or a first or second representation) of an element, includes position data and, as a general rule, image data.

Consequently, if an element has a first or second graphical representation constituted only of position data, it cannot be displayed on a screen. In this situation, the representation of the element defines its dimensions and position relative to the element that contains it within the level higher than its own, and consequently places the elements of levels lower than its own accurately relative to the elements of higher levels.

This situation corresponds to the case of the shelves Rj, which are shown in dashed outline in FIG. 5 to facilitate understanding the method of positioning superposed images of elements belonging to different levels. Here, the shelves Rj belonging to the second level have only one primary model defined by primary data that includes only position data.

It follows from the foregoing description that an equipment element has one or more attributes each defined by a file name.

The FIG. 5 example corresponds to the situation in which display of the first and lower levels has been requested, with no attachment to any level. Consequently, only the image data of the primary data that defines primary models of elements is displayed.

Here, the equipment is organized into four levels of elements. The first level is that of the single rack B (i=1), which has only one first representation (or primary model), as shown in FIG. 2. The second level is that of the two shelves R1 and R2 (j=1 or 2) housed in the rack B and the two light-emitting diodes LED1 and LED2 (k=1 or 2) integrated into the front panel of the rack B. The shelves R1 and R2 have only one primary model defined only by position data, and not by image data, whereas the two light-emitting diodes LED1 and LED2 have only a first representation (or primary model), as shown in FIG. 3. The third level is that of the five integrated circuit cards C-1-1 to C-1-5 (j=1, m=1 to 5), accommodated in the first shelf R1, and the five cards C-2-1 to C-2-5 (j=2, m=1 to 5), accommodated in the second shelf R2. These integrated circuit cards C have a first representation (or primary model), as shown in FIG. 3, and a second representation (or secondary model), as shown in FIG. 6. The fourth level is that of the twelve input/output ports P1 to P9 and PA to PC (j=1 or 2, m=1 to 5, n=1 to 9 and A to C) on the integrated circuit cards C, which have only a second representation (or secondary model), as shown in FIG. 7, corresponding to an attachment to the third level.

The input/output ports P-j-m-n having no first graphical representation, they cannot be displayed in the superposition of images shown in FIG. 5. On the other hand, they are displayed in the superposition of images shown in FIG. 8, which corresponds to a situation in which the display of a card C of the third level with its attachments to the elements of lower levels (here the input/output ports P of the fourth level) has been requested.

The display of images (or graphical representations) of elements belonging to different levels uses position data contained in the primary or secondary files. The position data preferably defines the position of an element of a given level relative to that of an element of the next higher level. This enables rapid display of the elements belonging to attached intermediate levels without using the position data of elements belonging to the highest levels (starting with the first level).

In the example shown in FIG. 5, the top left-hand corner of the rectangle, representing the rack B of the first level, serves as an origin O1 with coordinates (0,0) of an orthonomic system of axes (x,y) for the second level. The first shelf R1 is then positioned relative to the origin O1 and defines a new origin O2-1 for the subelements of the next lower level. The coordinates of O2-1 relative to O1 are, for example, (R1x,R1y). The second shelf R2 is positioned relative to the origin O1 and defines a new origin O2-2 for the subelements of the next lower level. The coordinates of O2-2 relative to O1 are, for example, (R2x,R2y). The light-emitting diodes LED1 and LED2 are positioned relative to the origin O1 and their coordinates relative to O1 are (LED1x,LED1y) and (LED2x,LED2y), for example. The cards C-1-1 to C-1-5 of the first shelf R1 are then positioned relative to the origin O2-1 and the cards C-2-1 to C-2-5 of the second shelf R2 are positioned relative to the origin O2-2. The coordinates of C-1-1 relative to O2-1 are, for example, (C-1-1x,C-1-1y) and the coordinates of C-2-1 relative to O2-2 are, for example, (C-2-1x,C-2-1y).

In the example shown in FIG. 8, the top left-hand corner of the rectangle, representing a card C of the third level, serves as an origin O′ with coordinates (0,0) of an orthonomic system of axes (x,y) at the fourth level. The input/output ports P1 to P9 and PA to PC of the card C are then positioned relative to the origin O′.

Moreover, as shown in FIG. 8, it is possible to display a label (or more generally information) on top of or alongside the images representative of elements. Here, it is the input/output ports P-j-m-n that have an inscription “Pn”, or “label” as they are also known, for distinguishing them and indicating their respective positions within the card C-j-m.

The following procedure may be adopted to implement the two display modes described hereinabove (without and with attachments). Of course, the method indicated, as used by the management system D according to the invention, is merely one nonlimiting embodiment of the invention.

The management system D includes a management module GM connected to a memory MM in which the primary and secondary files whose data define the primary and secondary models of the elements constituting the network equipment NE are stored.

The management module GM, which is connected to the graphical interface G, is responsible for analyzing requests to display elements entered by the manager of the network, in order to return to the latter data representative of the images of the elements requested.

As previously indicated, the manager of the network can request the display of two types of graphical representation. The first type relates to the display of element(s) belonging to a specified level and element(s) belonging to each level lower than the specified level, but with no attachment between the levels. In other words, this first type of display requires the extraction of the primary data that defines the primary models of the elements of a specified level to be included (for example Bi.gif, Lk.gif, Rj.gif and C-j-m.gif, as shown in FIG. 5). The second type relates to the display of element(s) belonging to a specified level and element(s) belonging to each level lower than the specified level, but with an attachment between the elements of the levels and the specified level. In other words, this second type of display requires the extraction of the secondary data that defines the secondary models of the elements of a specified level to be included (for example C-j-m_Level3.gif and P-j-m-n_Level3.gif, as shown in FIG. 8).

For example, to request the superposed display of the primary models of the elements that constitute a chosen equipment (as shown in FIG. 5), the manager enters a command that designates the first level of that equipment, for example “B”.

On receiving that command, the management module GM of the system D starts a processing procedure initiated by verifying the existence of the primary file “B.gif”. This verification can be effected in the memory MM, for example, using the command “B-drawSupported”. If the response to that command is “false”, the management module GM rejects the network manager's request. On the other hand, if the response to the command is “true”, the management module GM extracts the file “B.gif”, for example using the command “B.drawimage”. The image data of the primary file is then displayed immediately or after waiting for the end of the procedure in order for it to be displayed at the same time as the other images. The management module GM then verifies if there is a level lower than the first level that contains primary data. It can do this, for example, using the command “B.drawNextLevel”. If the response to that command is “false”, the management module GM applies the same verification procedure to the next lower level. On the other hand, if the response to the command is “true”, the management module GM proceeds to extract the designated file(s), for example using the commands “R1.drawImage”, “R2.drawImage”, “LED1.drawImage” and “LED2.drawImage”. In the example shown, the four files “R1.gif”, “R2.gif”, “LED1.gif” and “LED2.gif” of the second level are extracted successively. They respectively correspond to the first and second shelves R1, R2 and the first and second light-emitting diodes LED1, LED2. The image data from these primary files is then displayed immediately after realigning their position data relative to the origin of the element of the higher level that integrates them or after waiting for the end of the procedure in order for it to be displayed at the same time as the other images.

The management module GM then verifies for each element of the second level if primary data exists in the lower level (here the third level). It can do this, for example, using the commands “R1.drawNextLevel”, “R2.drawNextLevel”, “LED1.drawNextLevel” and “LED2.drawNextLevel”. If the response to any one of the above commands is “false”, the management module GM stops the verification procedure for the element concerned. In particular, this is the case here of the diodes LED that have no sublevel. On the other hand, if the response to any one of the commands is “true”, the management module GM proceeds to extract the designated file(s), for example using the commands “C-j-m-n.drawImage”. In the example shown, the first and second shelves R1, R2 each have a sublevel incorporating five integrated circuit cards associated with primary files. Consequently, the five primary files “C-1-1.gif” to “C-1-5.gif” of the cards of the third level integrated into the first shelf R1 and the five primary files “C-2-1.gif” to “C-2-5.gif” of the cards of the third level integrated into the second shelf R2 are extracted successively. The image data of these primary files is then displayed immediately after realigning their position data relative to the origin of the element of the higher level that integrates them or after waiting for the end of the procedure in order for it to be displayed at the same time as the other images.

The management module GM then verifies for each element of the third level if primary data exists in the lower level (here the fourth level). It can do this, for example, using the commands “C-j-m.drawNextLevel” (in which j=1 or 2 and m=1 to 5). Here there are two sets of secondary data in the fourth level, but no sets of primary data. Consequently, the response to each command “C-j-m.drawNextLevel” is “false”.

The result of the above extraction procedure is reflected in the superposition of the images of the primary models of the elements B, LEDk and C-j-m. As previously indicated, the primary files of the shelves R1 and R2 containing only position data for positioning the cards C-j-m of the lower level, the shelves are therefore not displayed.

To request the superposed display of the secondary models of elements that constitute a chosen equipment (as shown in FIG. 5), the manager first enters a command that designates an equipment element of a chosen level and specifies that he wishes to attach to it elements of lower levels. In other words, the manager indicates to the system D that he wishes to obtain detailed images of certain elements (this is the function known as the zoom function). For example, the manager wishes to see the secondary models of the element C-j-m of level 3 and of the elements of lower levels integrated therein (here the input/output ports P-j-m-n of the fourth level). It can do this, for example, by entering the command “C-j-m_Level3”.

On receiving this request, the management module GM of the system D starts a processing procedure initiated by verifying the existence of the secondary file “C-j-m_Level3.gif” in the memory MM. This verification can be effected in the memory MM using the command “C-j-m_Level3.drawSupported”, for example. If the response to this command is “false”, the management module GM rejects the network manager's request. On the other hand, if the response to this command is “true”, the management module GM starts by generating a command such as “C-j-m.drawName=“Level3”” indicating that all the elements that belong to levels lower than the third level of the element C-j-m and that have a secondary file with an extension “_Level3” must be extracted.

Then, it extracts the file “C-j-m_Level3.gif” using a command such as “C-j-m.drawImage_Level3”. The file is then either displayed immediately or after waiting for the end of the procedure in order for it to be displayed at the same time as the other images. The management module GM then verifies if there exists a level that contains secondary data and is lower than the third level. It can do this, for example, using the command “C-j-m_Level3.drawNextLevel”. If the response to this command is “false”, the management module GM effects the same verification at the next lower level. On the other hand, if the response to this command is “true”, which is the case here, the management module GM proceeds to extract the designated file(s), for example using the commands “P-j-m-n.drawImage_Level3”. In the example shown, the twelve files “P-j-m-n_Level3.gif” (where n=1 to 9 and A to C) of the fourth level are extracted successively. They correspond to respective input/output ports of the card C-j-m. The image data of these secondary files is then either displayed immediately after realigning their position data relative to the origin of the element of the higher level that integrates them or after waiting for the end of the procedure in order for it to be displayed at the same time as the other images.

Here the secondary files of the input/output ports include data (or “labels”, as they are also known) representative of the name of the port concerned (“Pn”). Consequently, in order to associate the associated label “Pn” with the image data of the input/output ports P-j-m-n, the management module GM generates a command for each port P-j-m-n, for example of the type “P-j-m-n_Level3.drawLabel”.

The management module GM next verifies for each element of the first level if there exist two sets of secondary data in the lower level (here the fifth level). It can do this, for example, using the commands “P-j-m-n_Level3.drawNextLevel”. The response to each of these commands here being “false”, the management module GM stops searching for images to display.

The result of this extraction procedure is the superposition of the images of the secondary models of the elements C-j-m and P-j-m-n, as shown in FIG. 8.

It is important to note that at least some of the secondary data of a set, which defines an element secondary model, can be identical to some of the primary data of a set which defines the primary model of that element. Moreover, an element can have a plurality of secondary models associated with different levels.

Also, the management module D can use other commands to process the data extracted from the primary and secondary files. These commands include, in particular:

“drawWidth” and “drawHeight” or “drawWidth_LevelX” and “drawHeight_LevelX” for resizing the width and height of an image defined by the primary or secondary data of a set attached to a level X;

“drawLabelx” and “drawLabelx” or “drawLabelx_LevelX” and “drawLabely_LevelX” for modifying the position (x,y) of a label to be associated with an image defined by the primary or secondary data of a set attached to a level X;

“drawLabelVertical” or “drawLabelVertical_LevelX” for displaying vertically a label to be associated with an image defined by the primary or secondary data of a set attached to a level X; in the absence of this command, the label is preferably displayed horizontally;

“drawLabelFontName”, “drawLabelFontType” and “drawLabelFontSize”, or “drawLabelFontName_LevelX”, “drawLabelFontType_LevelX” and “drawLabelFontSize_LevelX” for defining the characteristics of the font to be used.

Also, if the management system D according to the invention is connected to the control module CM of the management server S (as shown in FIG. 1), it is possible to add to the images of the elements displayed information representing the status of those elements, including their respective alarm states. This information is obtained by the control module CM, which uses the network management protocol (for example the Simple Network Management Protocol (SNMP)) to extract some values of fields contained in the management information bases MIB of the network equipments NE. Refreshing the display when the management module GM receives from the control module CM a message reporting that an event modifying the interactions between the elements displayed or the elements themselves or the information representing the status of the respective elements has occurred within the network can also be envisaged.

The management module GM of the management system D according to the invention can be implemented in the form of electronic circuits (hardware), software or data processing modules (software), or a combination of hardware and software. If at least a portion of the management module GM is implemented in the form of software modules, the latter preferably consist of program codes in Java.

The invention is not limited to the embodiments of the management system described hereinabove by way of example only, but encompasses all variants within the scope of the following claims that the person skilled in the art might envisage.

Thus a management system integrated into a management server, or even into its control module, has been described, but the management system could be installed in a unit connected to the control module of the management server.

Moreover, an example of displaying representations of elements organized in accordance with the hierarchical levels of rack, shelf and light-emitting diode, integrated circuit card, and input/output port has been described. However, the invention is not limited to this example of levels, and applies to all types of hierarchical levels.

1. A system (D) for managing the display of images representing network equipments (NE) of a communication network, said system including elements associated with hierarchical levels, and said system being characterized in that each equipment element is associated with a set of primary data stored in a memory (MM) which represents it within the level to which it belongs with no specific attachment to a level higher than itself and/or at least one set of secondary data stored in said memory (MM) which represents it within the level to which it belongs when it is attached to a level higher than or equal to its own, and in that it includes management means (GM) adapted, in the event of receiving a request designating a chosen level of a network equipment (NE) with or without attachment, to access said sets of primary and secondary data in order to extract from the memory the sets of primary or secondary data of the elements of the equipment that belong to said designated level and to levels lower than it, according to whether said level is designated with or without attachment.

2. A system according to claim 1, characterized in that said management means (GM) are adapted to send the extracted sets of primary or secondary data to a graphical interface (G).

3. A system according to claim 1, characterized in that some elements are associated with sets of primary and secondary data that are at least partly identical.

4. A system according to claim 1, characterized in that said management means (GM) are adapted to refresh the data of elements displayed in the event of receiving a message reporting that an event relating to said elements has occurred within the network.

5. A management server (S) of a communication network management system, characterized in that it includes a management system (D) according to any one of claims 1 to 4.

6. A server according to claim 5, characterized in that said management system (D) is installed in a control system (CM).

7. Use of the management system (D) and the server (S) according to any one of the preceding claims in the network technologies requiring to be managed.

8. Use according to claim 7, characterized in that said network technologies are chosen in a group comprising transmission networks, in particular WDM, SONET and SDH networks, data networks, in particular Internet-IP and ATM networks, and voice networks, in particular conventional, mobile and NGN networks.
